(19) United States
(12) Patent Application Publication
(10) Pub. No.: US 2006/0254427 A1
(43) Pub. Date: Nov. 16, 2006

(54) Particle-containing fibrous web

(75) Inventors: John E. Trend, St. Paul, MN (US); Philip G. Martin, Forest Lake, MN (US); Larry A. Brey, Woodbury, MN (US); Marvin E. Jones, Grant, MN (US); Larry A. Schumann, Woodbury, MN (US); Duane D. Fansler, Dresser, WI (US); Britton G. Billingsley, St. Paul, MN (US); Thomas I. Insley, Lake Elmo, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/431,152

(22) Filed: May 8, 2006

Related U.S. Application Data
(63) Continuation-in-part of application No. 10/983,770, filed on Nov. 8, 2004.

(51) Int. Cl. B01D 53/02

(52) U.S. Cl. 96/154

(57) ABSTRACT

A porous sheet article including a self-supporting nonwoven web of less than 20 weight percent polymeric fibers exhibiting no more than about 1 weight percent dimethyl methyl phosphonate uptake and at least 80 weight percent sorbent particles enmeshed in the web, the sorbent particles being sufficiently evenly distributed in the web and the fiber polymer(s) being such that the web has an Adsorption Factor A of at least 1.6×10⁴/mm water. The articles have low pressure drop and can provide filter elements and other individual or collective protection devices having long service lives and an Adsorption Factor approaching and in some instances exceeding that of a packed carbon bed.

### CROSS-REFERENCE TO RELATED APPLICATION

This application is a continuation-in-part of pending application Ser. No. 10/983,770 filed Nov. 8, 2004, the entire disclosure of which is incorporated herein by reference.

### TECHNICAL FIELD

This invention relates to particle-containing fibrous webs and filtration.

### BACKGROUND

Respiratory devices for use in the presence of solvents and other hazardous airborne substances sometimes employ a filtration element containing sorbent particles. The filtration element may be a cartridge containing a bed of the sorbent particles or a layer or insert of filtration material impregnated or coated with the sorbent particles. Design of the filtration element may involve a balance of sometimes competing factors such as pressure drop, surge resistance, overall service life, weight, thickness, overall size, resistance to potentially damaging forces such as vibration or abrasion, and sample-to-sample variability.

Packed beds of sorbent particles typically provide the longest service life in the smallest overall volume. Packed beds typically are formed by placing the sorbent particles in a rigid housing between thin scrim layers and compressing the resulting assembly so that the sorbent particles form a well-packed bed. The compression step helps prevent the target gas or vapor component from bypassing (“channeling”) the bed, but the rigid housing increases the filtration element weight, and the friable nature of some sorbents (e.g., carbon particles) may cause formation of fine particles which may undesirably escape from the bed during manufacturing, storage or use. The rigid housing, scrim layers and compression step can also increase pressure drop through the bed, thereby increasing breathing resistance. Fibrous webs loaded with sorbent particles often have lower pressure drop than a packed bed but may also have lower service life, greater bulk or larger sample-to-sample variability.

References relating to particle-containing fibrous webs include U.S. Pat. No. 2,988,469 (Watson), U.S. Pat. No. 3,971,373 (Braun), U.S. Pat. No. 4,429,001 (Kolpin et al.), U.S. Pat. No. 4,681,801 (Eian et al.), U.S. Pat. No. 4,741,949 (Morman et al.), U.S. Pat. No. 4,797,318 (Brooker et al. '318), U.S. Pat. No. 4,948,639 (Brooker et al. '639), U.S. Pat. No. 5,035,240 (Braun et al. '240), U.S. Pat. No. 5,328,758 (Markell et al.), U.S. Pat. No. 5,720,832 (Minto et al.), U.S. Pat. No. 5,972,427 (Mühlfeld et al.), U.S. Pat. No. 5,885,696 (Groeger), U.S. Pat. No. 5,952,092 (Groeger et al. '092), U.S. Pat. No. 5,972,808 (Groeger et al. '808), U.S. Pat. No. 6,024,782 (Freund et al.), U.S. Pat. No. 6,024,813 (Groeger et al. '813), U.S. Pat. No. 6,077,588 (Koslow et al. '588), U.S. Pat. No. 6,102,039 (Springett et al.) and PCT Published Application Nos. WO 00/39379 and WO 00/39380. References relating to other particle-containing filter structures include U.S. Pat. No. 3,217,715 (Berger wt al.), U.S. Pat. No. 3,474,600 (Tobias), U.S. Pat. No. 3,538,020 (Heskett et al.), U.S. Pat. No. 3,919,369 (Holden), U.S. Pat. No. 4,665,050 (Degen et al.), U.S. Pat. No. 4,790,306 (Braun et al. '306), U.S. Pat. No. 5,033,465 (Braun et al. '465), U.S. Pat. No. 5,078,132 (Braun et al. '132), U.S. Pat. No. 5,147,722 (Koslow), U.S. Pat. No. 5,332,426 (Tang et al.), U.S. Pat. No. 5,665,148 (Mühlfeld et al.), U.S. Pat. No. 6,391,429 (Senkus et al.) and U.S. Pat. No. 6,840,986 B1 (Koslow). Other references relating to fibrous webs include U.S. Pat. No. 4,657,802 (Morman).

### SUMMARY OF THE INVENTION

Although meltblown nonwoven webs containing activated carbon particles can be used to remove gases and vapors from air, it can be difficult to use such webs in replaceable filter cartridges for gas and vapor respirators. For example, when webs are formed from meltblown polypropylene and activated carbon particles, the readily-attainable carbon loading level ordinarily is about 100 to 200 g/m². If such webs are cut to an appropriate shape and inserted into replaceable cartridge housings, the cartridges may not contain enough activated carbon to meet capacity requirements set by the applicable standards-making bodies. Although higher carbon loading levels may be attempted, the carbon particles may fall out of the web thus making it difficult to handle the web in a production environment and difficult reliably to attain a targeted final capacity. Post-formation operations such as vacuum forming can also be employed to densify the web, but this requires additional production equipment and extra web handling.

Our above-mentioned application Ser. No. 10/983,770 describes highly-loaded particle-containing nonwoven webs fabricated from polymers whose fibers are sufficiently elastic or sufficiently shrink-prone and from sorbent particles that are sufficiently evenly distributed in the web so that the web has an Adsorption Factor A of at least 1.6×10⁴/mm water (viz., at least 1.6×10⁴ (mm water)⁻¹). The disclosed webs can be fashioned into porous sheet articles (e.g., replaceable filter elements for gas and vapor respirators) having a very desirable combination of high service life, low pressure drop and relatively low carbon shedding tendencies. The disclosed filter elements are especially useful for mass producing replaceable filter cartridges using automated equipment.

The Adsorption Factor A is affected by several factors discussed in more detail below. In general for a given vapor-absorbing filtration material, a large Adsorption Factor A will correspond to a desirable combination of favorable cyclohexane vapor absorption kinetics, long service life before breakthrough of objectionable vapor levels, and low filter pressure drop. We observed especially large Adsorption Factor A values for webs made from thermoplastic polyurethanes and about 86 weight or more percent carbon particles. Several such webs unexpectedly exhibited an Adsorption Factor A greater than that of a high-quality packed carbon bed (viz., greater than about 3.16×10⁴/mm water).

Our Adsorption Factor A measurements were made using cyclohexane. We also prepared sorbent filtration webs made from thermoplastic polyurethane fibers and about 86 to 91 weight percent carbon particles, exposed them to a number of other organic materials, and obtained generally favorable results. One such organic material, namely dimethyl methyl phosphonate (“DMMP”), also was efficiently absorbed. However, rather than only being absorbed by the carbon particles, DMMP also appeared to have been absorbed as well by the polyurethane web fibers. Such fiber absorption might cause weakening or other degradation of the web structure.

Polypropylene has previously been regarded as an especially good material for making carbon-loaded webs. DMMP is not appreciably absorbed by polypropylene web fibers, and has not previously been a problem in such webs even at high carbon loading levels.

The present invention provides, in one aspect, a porous sheet article comprising a self-supporting nonwoven web of less than 20 weight percent polymeric fibers exhibiting no more than about 1 weight percent dimethyl methyl phosphonate uptake and at least 80 weight percent sorbent particles enmeshed in the web, the sorbent particles being sufficiently evenly distributed in the web and the fiber polymer(s) being such that the web has an Adsorption Factor A of at least 1.6×10⁴/mm water.

In another aspect, the invention provides a process for making a porous sheet article comprising a self-supporting nonwoven web of polymeric fibers and sorbent particles, the process comprising:
a) flowing molten polymer through a plurality of orifices to form filaments;
b) attenuating the filaments into fibers;
c) directing a stream of sorbent particles amidst the filaments or fibers; and
d) collecting the fibers and sorbent particles as a nonwoven web comprising less than 20 weight percent polymeric fibers exhibiting no more than about 1 weight percent dimethyl methyl phosphonate uptake and at least 80 weight percent sorbent particles enmeshed in the web
   wherein the sorbent particles are sufficiently evenly distributed in the web and the polymer is such that that the web has an Adsorption Factor A of at least 1.6×10⁴/mm water.

In another aspect the invention provides a respiratory device having an interior portion that generally encloses at least the nose and mouth of a wearer, an air intake path for supplying ambient air to the interior portion, and a porous sheet article disposed across the air intake path to filter such supplied air, the porous sheet article comprising a self-supporting nonwoven web of less than 20 weight percent polymeric fibers exhibiting no more than about 1 weight percent dimethyl methyl phosphonate uptake and at least 80 weight percent sorbent particles enmeshed in the web, the sorbent particles being sufficiently evenly distributed in the web and the fiber polymer(s) being such that the article has an Adsorption Factor A of at least 1.6×10⁴/mm water.

In yet another aspect the invention provides a replaceable filter element for a respiratory device, the element comprising a support structure for mounting the element on the device, a housing and a porous sheet article disposed in the housing so that the element can filter air passing into the device, the article comprising a self-supporting nonwoven web of less than 20 weight percent polymeric fibers exhibiting no more than about 1 weight percent dimethyl methyl phosphonate uptake and at least 80 weight percent sorbent particles enmeshed in the web, the sorbent particles being sufficiently evenly distributed in the web and the fiber polymer(s) being such that that the element has an Adsorption Factor A of at least 1.6×10⁴/mm water.

These and other aspects of the invention will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWING

FIG. 1 is a schematic cross-sectional view of a disclosed porous sheet article;

FIG. 2 is a schematic cross-sectional view of a disclosed multilayer porous sheet article;

FIG. 3 is a schematic view, partially in cross-section, of a disclosed replaceable filter element;

FIG. 4 is a perspective view of a disclosed respiratory device utilizing the element of FIG. 3;

FIG. 5 is a perspective view, partially cut away, of a disclosed disposable respiratory device utilizing the porous sheet article of FIG. 1;

FIG. 6 is a schematic cross-sectional view of a meltblowing apparatus for making porous sheet articles.

FIG. 7 is a schematic cross-sectional view of a spun bond process apparatus for making porous sheet articles.

FIG. 8 is a schematic cross-sectional view of another meltblowing apparatus for making porous sheet articles.

FIG. 9 and FIG. 10 are graphs showing service life comparisons.

Like reference symbols in the various figures of the drawing indicate like elements. The elements in the drawing are not to scale.

### DETAILED DESCRIPTION

As used in this specification with respect to a sheet article, the word “porous” refers to an article that is sufficiently permeable to gases so as to be useable in a filter element of a personal respiratory device.

The phrase “nonwoven web” refers to a fibrous web characterized by entanglement or point bonding of the fibers.

The term “self-supporting” refers to a web having sufficient coherency and strength so as to be drapable and handleable without substantial tearing or rupture.

The phrase “attenuating the filaments into fibers” refers to the conversion of a segment of a filament into a segment of greater length and smaller diameter.

The word “meltblowing” means a method for forming a nonwoven web by extruding a fiber-forming material through a plurality of orifices to form filaments while contacting the filaments with air or other attenuating fluid to attenuate the filaments into fibers and thereafter collecting a layer of the attenuated fibers.

The phrase “melt blown fibers” refers to fibers made using meltblowing. The aspect ratio (ratio of length to diameter) of melt blown fibers is essentially infinite (e.g., generally at least about 10,000 or more), though melt blown fibers have been reported to be discontinuous. The fibers are long and entangled sufficiently that it is usually not possible to remove one complete melt blown fiber from a mass of such fibers or to trace one melt blown fiber from beginning to end.

The phrase “spun bond process” means a method for forming a nonwoven web by extruding a low viscosity melt through a plurality of orifices to form filaments, quenching the filaments with air or other fluid to solidify at least the surfaces of the filaments, contacting the at least partially solidified filaments with air or other fluid to attenuate the filaments into fibers and collecting and optionally calendaring a layer of the attenuated fibers.

The phrase “spun bond fibers” refers to fibers made using a spun bond process. Such fibers are generally continuous and are entangled or point bonded sufficiently that it is usually not possible to remove one complete spun bond fiber from a mass of such fibers.

The phrase “nonwoven die” refers to a die for use in meltblowing or the spun bond process.

The word “enmeshed” when used with respect to particles in a nonwoven web refers to particles that are sufficiently bonded to or entrapped within the web so as to remain within or on the web when the web is subjected to gentle handling such as draping the web over a horizontal rod.

The phrase “exhibiting no more than about 1 weight percent DMMP uptake” when used with respect to polymeric fibers refers to the weight change in an unloaded web of such fibers (viz., a sorbent-free web made from otherwise similar polymeric fibers) after the unloaded web has been placed in air saturated with DMMP vapor at room temperature for six days. This may be carried out by placing the unloaded web in a sealed desiccator containing liquid DMMP. The web is not allowed to contact the liquid DMMP.

The phrase “elastic limit” when used with respect to a polymer refers to the maximum distortion that a body formed from the polymer can undergo and return to its original form when relieved from stress.

The words “elastic” or “elasticity” when used with respect to a polymer refer to a material that has an elongation at its elastic limit of greater than about 10% as measured using ASTM D638-03, Standard Test Method for Tensile Properties of Plastics.

The phrase “crystallization shrinkage” refers to the irreversible change in length of an unconstrained fiber that may occur when the fiber passes from a less ordered, less crystalline state to a more ordered, more crystalline state, e.g. due to polymer chain folding or polymer chain rearrangement.

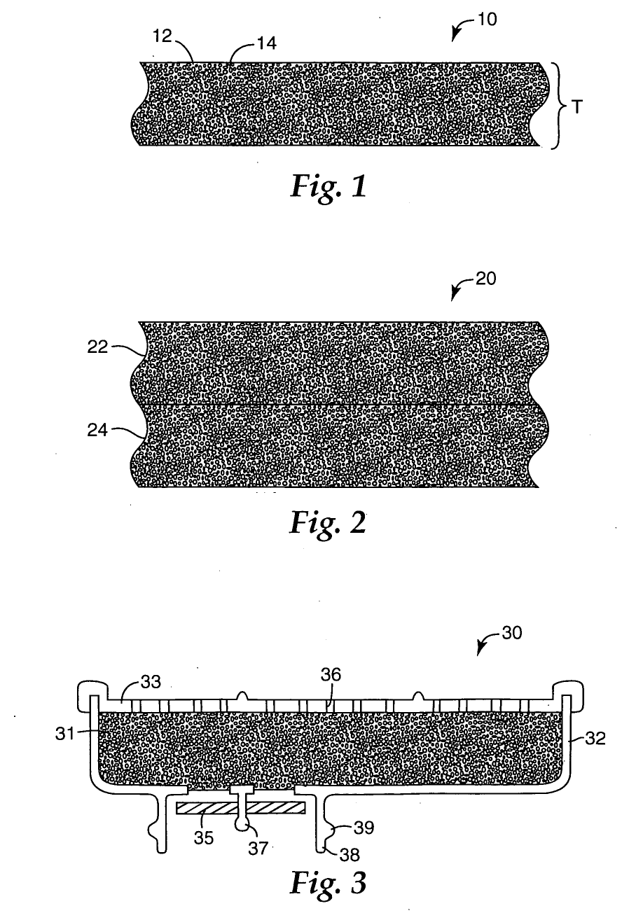

Referring to FIG. 1, a disclosed porous sheet article 10 is shown schematically in cross-section. Article 10 has a thickness T and a length and width of any desired dimension. Article 10 is a nonwoven web containing entangled polymeric fibers 12 and sorbent carbon particles 14 enmeshed in the web. Small connected pores (not identified in FIG. 1) in article 10 permit ambient air or other fluids to pass (e.g., to flow) through the thickness dimension of article 10. Particles 14 absorb solvents and other potentially hazardous substances present in such fluids. Fibers 12 desirably do not absorb, adsorb, solvate or otherwise exhibit uptake of such substances.

FIG. 2 shows a cross-sectional view of a disclosed multilayer article 20 having two nonwoven layers 22 and 24. Layers 22 and 24 each contain fibers and sorbent particles (not identified in FIG. 2). Layers 22 and 24 may be the same as or different from one another and may be the same as or different from article 10 in FIG. 1. For example, when the sorbent particles in layers 22 and 24 are made from different substances, then different potentially hazardous substances may be removed from fluids passing through article 20. When the sorbent particles in layers 22 and 24 are made from the same substances, then potentially hazardous substances may be removed more effectively or for longer service periods from fluids passing through the thickness dimension article 20 than from a single layer article of equivalent overall composition and thickness. Multilayer articles such as article 20 can if desired contain more than two nonwoven layers, e.g. three or more, four or more, five or more or even 10 or more layers.

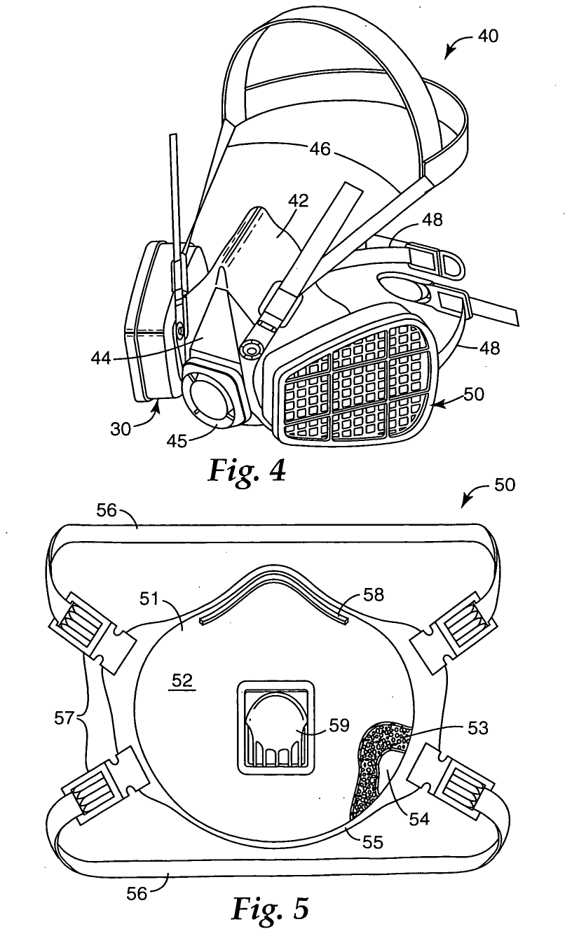

FIG. 3 shows a cross-sectional view of disclosed filter element 30. The interior of element 30 can be filled with a porous sheet article 31 such as those shown in FIG. 1 or FIG. 2. Housing 32 and perforated cover 33 surround sheet article 31. Ambient air enters filter element 30 through openings 36, passes through sheet article 31 (whereupon potentially hazardous substances in such ambient air are absorbed by particles in sheet article 31) and exits element 30 past intake air valve 35 mounted on support 37. Spigot 38 and bayonet flange 39 enable filter element 30 to be replaceably attached to a respiratory device such as disclosed device 40 in FIG. 4. Device 40 is a so-called half mask like that shown in U.S. Pat. No. 5,062,421 (Burns et al.). Device 40 includes soft, compliant face piece 42 that can be insert molded around relatively thin, rigid structural member or insert 44. Insert 44 includes exhalation valve 45 and recessed bayonet-threaded openings (not shown in FIG. 4) for removably attaching filter elements 30 in the cheek regions of device 40. Adjustable headband 46 and neck straps 48 permit device 40 to be securely worn over the nose and mouth of a wearer. Further details regarding the construction of such a device will be familiar to those skilled in the art.

FIG. 5 shows a disclosed respiratory device 50 in partial cross-section. Device 50 is a disposable mask like that shown in U.S. Pat. No. 6,234,171 B1 (Springett et al.). Device 50 has a generally cup-shaped shell or respirator body 51 made from an outer cover web 52, nonwoven web 53 containing sorbent particles such as those shown in FIG. 1 or FIG. 2, and inner cover web 54. Welded edge 55 holds these layers together and provides a face seal region to reduce leakage past the edge of device 50. Device 50 includes adjustable head and neck straps 56 fastened to device 50 by tabs 57, pliable dead-soft metal nose band 58 of a metal such as aluminum and exhalation valve 59. Further details regarding the construction of such a device will be familiar to those skilled in the art.

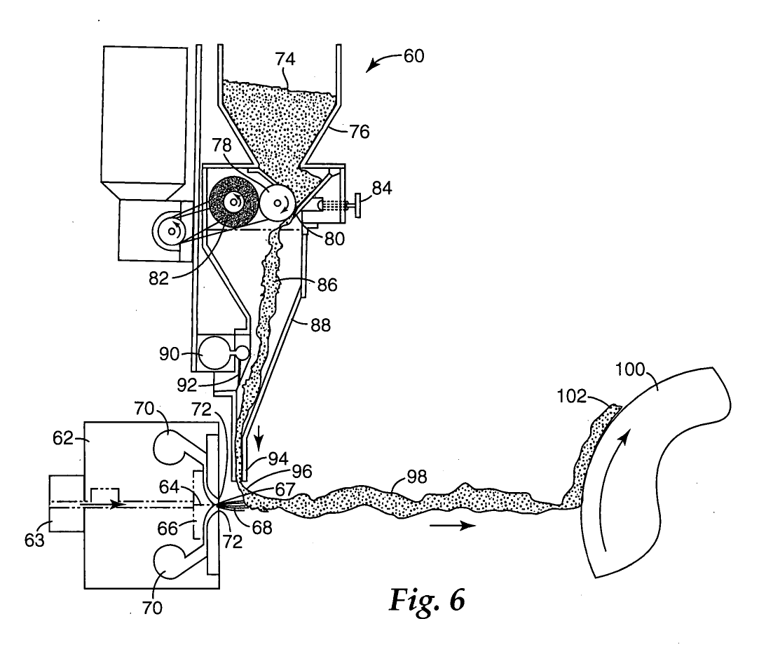

FIG. 6 shows a disclosed apparatus 60 for making nonwoven particle-loaded webs using meltblowing. Molten fiber-forming polymeric material enters nonwoven die 62 via inlet 63, flows through die slot 64 of die cavity 66 (all shown in phantom), and exits die cavity 66 through orifices such as orifice 67 as a series of filaments 68. An attenuating fluid (typically air) conducted through air manifolds 70 attenuates filaments 68 into fibers 98. Meanwhile, sorbent particles 74 pass through hopper 76 past feed roll 78 and doctor blade 80. Motorized brush roll 82 rotates feed roll 78. Threaded adjuster 84 can be moved to improve crossweb uniformity and the rate of particle leakage past feed roll 78. The overall particle flow rate can be adjusted by altering the rotational rate of feed roll 78. The surface of feed roll 78 may be changed to optimize feed performance for different particles. A cascade 86 of sorbent particles 74 falls from feed roll 78 through chute 88. Air or other fluid passes through manifold 90 and cavity 92 and directs the falling particles 74 through channel 94 in a stream 96 amidst filaments 68 and fibers 98. The mixture of particles 74 and fibers 98 lands against porous collector 100 and forms a self-supporting nonwoven particle-loaded meltblown web 102. Further details regarding the manner in which meltblowing would be carried out using such an apparatus will be familiar to those skilled in the art.

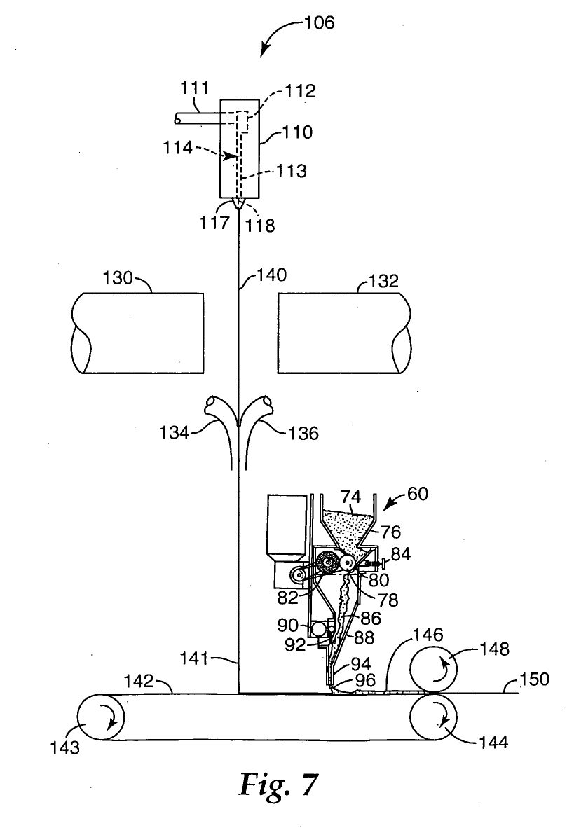

FIG. 7 shows a disclosed apparatus 106 for making nonwoven particle-loaded webs using a spun bond process. Molten fiber-forming polymeric material enters generally vertical nonwoven die 110 via inlet 111, flows downward through manifold 112 and die slot 113 of die cavity 114 (all shown in phantom), and exits die cavity 114 through orifices such as orifice 118 in die tip 117 as a series of downwardly-extending filaments 140. A quenching fluid (typically air) conducted via ducts 130 and 132 solidifies at least the surfaces of the filaments 140. The at least partially solidified filaments 140 are drawn toward collector 142 while being attenuated into fibers 141 by generally opposing streams of attenuating fluid (typically air) supplied under pressure via ducts 134 and 136. Meanwhile, sorbent particles 74 pass through hopper. 76 past feed roll 78 and doctor blade 80 in an apparatus like that shown by components 76 through 94 in FIG. 6. Stream 96 of particles 74 is directed through nozzle 94 amidst fibers 141. The mixture of particles 74 and fibers 141 lands against porous collector 142 carried on rollers 143 and 144 and forms a self-supporting nonwoven particle-loaded spun bond web 146. Calendaring roll 148 opposite roll 144 compresses and point-bonds the fibers in web 146 to produce calendared spun bond nonwoven particle-loaded web 150. Further details regarding the manner in which spun bonding would be carried out using such an apparatus will be familiar to those skilled in the art.

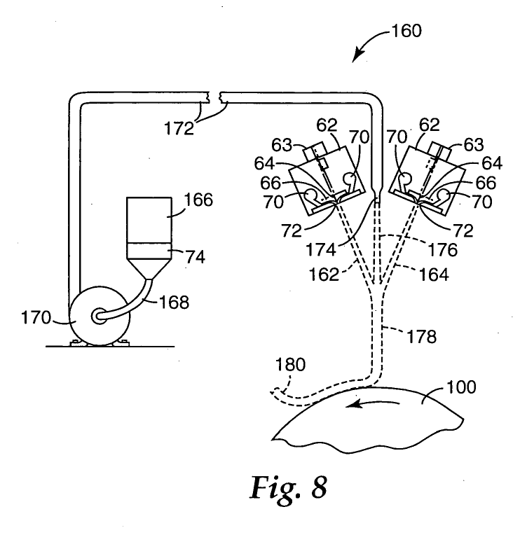

FIG. 8 shows a disclosed apparatus 160 for making nonwoven particle-loaded webs using meltblowing. This apparatus employs two generally vertical, obliquely-disposed nonwoven dies 66 that project generally opposing streams of filaments 162, 164 toward collector 100. Meanwhile, sorbent particles 74 pass through hopper 166 and into conduit 168. Air impeller 170 forces air through a second conduit 172 and accordingly draws particles from conduit 168 into the second conduit 172. The particles are ejected through nozzle 174 as particle stream 176 whereupon they mingle with the filament streams 162 and 164 or with the resulting attenuated fibers 178. The mixture of particles 74 and fibers 178 lands against porous collector 100 and forms a self-supporting nonwoven particle-loaded nonwoven web 180. Further details regarding the manner in which meltblowing would be carried out using the FIG. 8 apparatus will be familiar to those skilled in the art.

A variety of fiber-forming polymeric materials can be employed, including thermoplastics and especially extensible thermoplastics such as linear low density polyethylenes (e.g., those available under the trade designation DOWLEX™ from Dow Chemical Company), polyolefin elastomers (e.g., those available under the trade designations ENGAGE™ from Dow Chemical Company and VISTAMAXX™ from ExxonMobil Chemical Company), ethylene alpha-olefin copolymers (e.g., the ethylene butene, ethylene hexene or ethylene octene copolymers available under the trade designations EXACT™ from ExxonMobil Chemical Company and ENGAGE™ from Dow Chemical Company), ethylene vinyl acetate polymers (e.g., those available under the trade designations ELVAX™ from E. I. DuPont de Nemours & Co.), polybutylene elastomers (e.g., those available under the trade designations CRASTIN™ from E. I. DuPont de Nemours & Co. and POLYBUTENE-1™ from Basell Polyolefins), elastomeric styrenic block copolymers (e.g., those available under the trade designations KRATON™ from Kraton Polymers and SOLPRENE™ from Dynasol Elastomers) and polyether block copolyamide elastomeric materials (e.g., those available under the trade designation PEBAX™ from Atofina Chemicals, Inc.). Polyolefin elastomers are especially preferred. The polymeric material may if desired be made from comonomers or modified with reactive species that alter the polymeric material backbone. Desirably however the polymeric material is not modified with reactive species that cause the disclosed webs to exhibit objectionable levels of DMMP uptake or to exhibit low Adsorption Factor A values. For example, unloaded webs based on the EVA polymer ELVAX 3174 appear to exhibit less than 1 wt. % DMMP uptake. However, tests carried out by exposing a solid disc of the anhydride-modified EVA polymer BYNEL 3022 to air saturated with DMMP vapor indicate that an unloaded web made from BYNEL 3022 EVA might absorb considerably greater amounts of DMMP.

The disclosed webs may be made from blends of polymeric materials, e.g., blends of polyolefin elastomers and elastomeric styrenic block copolymers. If desired, a portion of the disclosed web can represent polymers or other fibrous or fiber-forming materials which would not by themselves exhibit adequate resistance to DMMP uptake or which would not by themselves provide a web with the desired Adsorption Factor A. For example, suitably loaded webs made from the linear low density polyethylene DOWLEX 2517 are shown below to have an Adsorption Factor A of about 2.1×10⁴/mm water, whereas a similarly loaded web made from the linear low density polyethylene DOWLEX 2503 is shown below to have an Adsorption Factor A of about 1.0×10⁴/mm water. Also, unloaded webs made from 90:10 and 50:50 blends of the polyolefin elastomer ENGAGE 8402 and the styrenic block copolymer KRATON G1657 are shown below to have very low DMMP uptake, and a 91 wt % carbon-loaded web in which the polymeric material is only ENGAGE 8402 is shown below to have an Adsorption Factor A of about 2.6×10⁴/mm water, whereas an 88 wt. % carbon-loaded web in which the polymeric material is only KRATON G1657 is shown below to exhibit an Adsorption Factor A of about 1.4×10⁴/mm water.

The disclosed webs may also or in addition be formed from multicomponent fibers such as core-sheath fibers, splittable or side-by-side bicomponent fibers or so-called “islands in the sea” fibers with one or more but not necessarily all of the polymeric components being materials such as those described above. In addition, the disclosed webs may be formed using other polymeric materials as one or more of the components, or by adding other fibrous or fiber-forming materials including staple fibers (e.g., of natural or synthetic materials) and the like. Preferably however relatively low amounts of such other fibrous or fiber-forming materials are employed in the disclosed webs so as not to detract unduly from the desired sorbent particle loading level and finished web properties.

The polymer fibers as noted above exhibit no more than about 1 weight percent DMMP uptake after an unloaded web of such fibers has been exposed to air saturated with DMMP vapor at room temperature for six days. The polymer fibers may under such conditions exhibit no more than about 0.5 weight percent DMMP uptake, no more than about 0.3 weight percent DMMP uptake or no more than about 0.2 weight percent DMMP uptake. More accurate DMMP uptake measurements may be obtained using larger samples, and thus it is desirable to employ an unloaded web sample weighing at least 0.4 g, more preferably at least 0.5 g and yet more preferably at least 1 g or even 10 g.

The polymer may in fiber form have (but is not required to have) greater elasticity than similar caliper polypropylene fibers. The polymer also may be but is not required to be elastomeric, viz., a material which may be stretched to at least 125 percent of its initial relaxed length and which will recover to substantially its initial relaxed length upon release of the biasing force. The polymer also may in fiber form have (but is not required to have) greater crystallization shrinkage than similar caliper polypropylene fibers. Without intending to be bound by theory, we believe that fibers having such elasticity or crystallization shrinkage characteristics may promote autoconsolidation or densification of the disclosed webs, reduction in the web pore volume or reduction in the pathways through which gases can pass without encountering an available sorbent particle. Densification may be promoted in some instances by forced cooling of the web using, e.g., a spray of water or other cooling fluid, or by annealing the collected web in an unrestrained or restrained manner. Preferred annealing times and temperatures will depend on various factors including the polymeric fibers employed and the sorbent particle loading level.

A variety of sorbent particles can be employed. Desirably the sorbent particles will be capable of absorbing or adsorbing gases, aerosols or liquids expected to be present under the intended use conditions. The sorbent particles can be in any usable form including beads, flakes, granules or agglomerates. Preferred sorbent particles include activated carbon; alumina and other metal oxides; sodium bicarbonate; metal particles (e.g., silver particles) that can remove a component from a fluid by adsorption, chemical reaction, or amalgamation; particulate catalytic agents such as hopcalite (which can catalyze the oxidation of carbon monoxide); clay and other minerals treated with acidic solutions such as acetic acid or alkaline solutions such as aqueous sodium hydroxide; ion exchange resins; molecular sieves and other zeolites; silica; biocides; fungicides and virucides. Activated carbon and alumina are particularly preferred sorbent particles. Mixtures of sorbent particles can be employed, e.g., to absorb mixtures of gases, although in practice to deal with mixtures of gases it may be better to fabricate a multilayer sheet article employing separate sorbent particles in the individual layers. The desired sorbent particle size can vary a great deal and usually will be chosen based in part on the intended service conditions. As a general guide, the sorbent particles may vary in size from about 5 to 3000 micrometers average diameter. Preferably the sorbent particles are less than about 1500 micrometers average diameter, more preferably between about 30 and about 800 micrometers average diameter, and most preferably between about 100 and about 300 micrometers average diameter. Mixtures (e.g., bimodal mixtures) of sorbent particles having different size ranges can also be employed, although in practice it may be better to fabricate a multilayer sheet article employing larger sorbent particles in an upstream layer and smaller sorbent particles in a downstream layer. At least 80 weight percent sorbent particles, more preferably at least 84 weight percent and most preferably at least 90 weight percent sorbent particles are enmeshed in the web. Expressed in terms of the web basis weight, the sorbent particle loading level may for example be at least about 500 g/m² (gsm) for relatively fine (viz., small diameter) sorbent particles, and at least about 2,000 g/m² for relatively coarse sorbent particles.

In some embodiments the service life may be affected by whether the collector side of the disclosed web is oriented upstream or downstream with respect to the expected fluid flow direction. Depending sometimes on the particular sorbent particle employed, improved service lives have been observed using both orientations. As noted above, service life may also be affected by employing layers of webs containing differently-sized sorbent particles.

The disclosed nonwoven web or filter element has an Adsorption Factor A of at least 1.6×10⁴/mm water. The Adsorption Factor A can be calculated using parameters or measurements similar to those described in Wood, Journal of the American Industrial Hygiene Association, 55(1):11-15 (1994), where:
kᵥ=effective adsorption rate coefficient (min⁻¹) for the capture of C₆H₁₂ vapor by the sorbent according to the equation:
   C₆H₁₂ vapor→C₆H₁₂ absorbed on the sorbent.
Wₑ=effective adsorption capacity (gC₆H₁₂/gSorbent) for a packed sorbent bed or sorbent loaded web exposed to 1000 ppm C₆H₁₂ vapor flowing at 30 L/min (face velocity 4.9 cm/s) and standard temperature and pressure, determined using iterative curve fitting for an adsorption curve plotted from 0 to 50 ppm (5%) C₆H₁₂ breakthrough.
SL=service life (min) for a packed sorbent bed or sorbent loaded web exposed to 1000 ppm C₆H₁₂ vapor flowing at 30 L/min (face velocity 4.9 cm/s) and standard temperature and pressure, based on the time required to reach 10 ppm (1%) C₆H₁₂ breakthrough.
ΔP=pressure drop (mm water) for a packed sorbent bed or sorbent loaded web exposed to air flowing at 85 L/min (face velocity 13.8 cm/s) and standard temperature and pressure.
The parameter kᵥ is usually not measured directly. Instead, it can be determined by solving for kᵥ using multivariate curve fitting and the equation:

$$\frac{Cx}{Co} = {( 1 + exp [ \frac{kv ⨯ W}{ρ β ⨯ Q} - \frac{kv ⨯ Co ⨯ t}{We ⨯ ρ β ⨯ {10}^{3}} ] )}^{- 1}$$

where
Q=Challenge flow rate (L/min)
Cx=C₆H₁₂ exit concentration (g/L).
Co=C₆H₁₂ inlet concentration (g/L).
W=sorbent weight (g).
t=exposure time.
ρβ=density of a packed sorbent bed or the effective density of a sorbent loaded web where g_{Sorbent} is the weight of sorbent material (excluding the web weight, if present), cm³_{Sorbent} is the overall volume of sorbent, cm³_{Web} is the overall volume of sorbent loaded web, and ρβ has the units g_{Sorbent}/cm³_{Sorbent} for a packed bed or g_{Sorbent}/cm³_{Web} for a sorbent loaded web.
   The Adsorption Factor A can then be determined using the equation:
   A=(kᵥ×SL)/ΔP.
   The Adsorption Factor may be for example at least 2×10⁴/mm water, at least 3×10⁴/mm water, at least 4×10⁴/mm water or at least 5×10⁴/mm water. Surprisingly, some embodiments of the invention have Adsorption Factors above those found in a high-quality packed carbon bed, which as shown in Comparative Example 1 below is about 3.16×10⁴/mm water.

A further factor Aᵥₒₗ which relates the Adsorption Factor A to the total product volume can also be calculated. Aᵥₒₗ has the units g_{Sorbent}/cm³_{Web}-mm water, and can be calculated using the equation:
Aᵥₒₗ=A×ρβ
Preferably Aᵥₒₗ is at least about 3×10³ g_{Sorbent}/cm³_{Web}-mm water, more preferably at least about 6×10³ g_{Sorbent}/cm³_{Web}-mm water, and most preferably at least about 9×10³ g_{Sorbent}/cm³_{Web}-mm water.

The disclosed porous sheet materials may be used to capture or adsorb a wide variety of chemical materials, including organic solvents, inorganic vapors and other materials that will be familiar to those skilled in the art. As will be familiar to those skilled in the art, one or more additional layers such as cover web(s), stiffening layer(s), particulate filtration layer(s) such as charged nonwoven webs or other functional or decorative layers may also be employed. The disclosed porous sheet materials are especially useful for fabricating replaceable cartridges for personal respirators intended for use in solvent-containing atmospheres. However, the disclosed porous sheet materials have a variety of additional uses. For example, they may be employed in personal or collective protective equipment such as chemical protective suits, hoods, individual enclosures (e.g., isolation chambers), shelters (e.g., tents or other portable or permanent structures) and other personal or collective protection devices into which air is filtered through the porous sheet article. The disclosed porous sheet materials may also be supported by a suitable housing to provide a filter for conditioning the gases entering into or circulating in an enclosed area such as a building or vehicle. The disclosed porous sheet materials may also be used to provide a prefilter or postfilter that can be combined with a further (e.g., an existing) filter structure. Additional uses will be familiar to those skilled in the art.

The invention will now be described with reference to the following non-limiting examples, in which all parts and percentages are by weight unless otherwise indicated.

### EXAMPLE 1

Using a meltblowing apparatus with a single horizontal stream of filaments like that shown in FIG. 6, a 230-300° C. polymer melt temperature (depending on the polymer and desired fiber size), a drilled orifice die and a 32 cm die-to-collector distance, a series of meltblown carbon-loaded nonwoven webs was prepared using various fiber-forming polymeric materials extruded at about 300 g/hour/cm of die width for the thermoplastic polyurethane used in Run No. 2 (see Table 1, shown below) and about 230 g/hour/cm of die width for the remaining polymeric materials shown in Table 1. The extruder temperature and air velocity (and as needed, other processing parameters) were adjusted to obtain webs having about a 16 to 29 micrometer effective fiber diameter (“EFD”), with most of the webs having about a 20 to 29 micrometer EFD. EFD values were determined using an air flow rate of 32 L/min (corresponding to a face velocity of 5.3 cm/sec) according to the method set forth in Davies, C. N., “The Separation of Airborne Dust and Particles”, Institution of Mechanical Engineers, London, Proceedings 1B, 1952, by examining swatches of unloaded web made before the sorbent particles were allowed to fall from feed roll 78 (see FIG. 6) into the web. Some of the webs were annealed as indicated below. The completed webs were evaluated to determine the carbon loading level and the parameters EFD, kᵥ, SL, ΔP, ρβ, A and Aᵥₒₗ. For some webs data was obtained using a stack of 2-4 webs. For these webs the ratio SL/ΔP provided a somewhat more useful measurement than the individual SL and ΔP values. For other webs data was obtained using a single layer web and recording SL, ΔP and SL/ΔP. Comparison data was gathered for a 104 cm³ packed carbon bed made from Kuraray Type GG 12×20 activated carbon and for webs made from polypropylene. Set out below in Table 1 are the Run Number, polymeric material, carbon sieve size, carbon loading level, effective fiber diameter (EFD), and the parameters EFD, SL (where noted), kᵥ, SL/ΔP, ρβ, A and Aᵥₒₗ. The entries in Table 1 are sorted in descending order according to the Adsorption Factor A value.

TABLE 1

| | | | | | | | | | | Aᵥₒₗ, |
|---|---|---|---|---|---|---|---|---|---|---|
| | | Carbon | | | | | SL/ΔP, | | | g_{sorbent}/ |
| | Polymeric | Sieve | Loading | EFD, | SL, | kᵥ, | min/mm | ρβ, | A, | cm³ Web- |
| Run No. | Material | Size | Level, % | μm | min | min⁻¹ | H₂O | g/cm³ | /mm water | mm water |
| 1 | EXACT 3040⁽¹⁾ | 12 × 20 | 91 | 29 | 24.2 | 2611 | 12.8 | 0.24 | 33371 | 8065 |
| 2 | PS440-200⁽²⁾ | 12 × 20 | 91 | 20.4 | — | 1946 | 17 | 0.21 | 33082 | 6947 |
| 3 | None (packed | 12 × 20 | 100 | — | — | 7220 | 4.1 | 0.43 | 29602 | 12729 |
| | 104 cm³ bed) | | | | | | | | | |
| 4 | VISTAMAXX | 12 × 20 | 92 | 29.2 | 23.2 | 2025 | 13.7 | 0.22 | 27653 | 6017 |
| | VM2125⁽³⁾ | | | | | | | | | |
| 5 | ENGAGE | 12 × 20 | 91 | 24.7 | 25.8 | 2911 | 8.9 | 0.23 | 25875 | 5904 |
| | 8402⁽⁴⁾ | | | | | | | | | |
| 6 | 50% FINA | 12 × 20 | 90 | 21.5 | — | 1726 | 13.5 | 0.20 | 23301 | 4660 |
| | 3868⁽⁵⁾ + 50% | | | | | | | | | |
| | PB 0400⁽⁶⁾ | | | | | | | | | |
| 7 | 50% FINA | 12 × 20 | 90 | 21.5 | — | 1757 | 13.2 | 0.20 | 23192 | 4638 |
| | 3868⁽⁵⁾ + 50% | | | | | | | | | |
| | PB 0400⁽⁶⁾ (web | | | | | | | | | |
| | annealed 5 min.) | | | | | | | | | |
| 8 | DOWLEX | 12 × 20 | 90 | 29.2 | 13.2 | 2368 | 8.7 | 0.22 | 21031 | 4706 |
| | 2517⁽⁷⁾ | | | | | | | | | |
| 9 | 100% PB | 12 × 20 | 90 | 20.7 | — | 1868 | 10.1 | 0.20 | 18864 | 3716 |
| | 0400⁽⁶⁾ | | | | | | | | | |
| 10 | VISTAMAXX | 40 × 140 | 96 | 21.1 | 13.5 | 9562 | 2.0 | 0.28 | 18754 | 5174 |
| | VM2330⁽⁸⁾ | | | | | | | | | |
| 11 | 20% FINA | 12 × 20 | 89 | 20.3 | — | 1922 | 9.7 | 0.20 | 18643 | 3729 |
| | 3868⁽⁵⁾ + 80% | | | | | | | | | |
| | PB 0400⁽⁶⁾ | | | | | | | | | |
| 12 | 100% PB | 12 × 20 | 90 | 20.7 | — | 1802 | 9.4 | 0.20 | 16936 | 3336 |
| | 0400⁽⁶⁾ | | | | | | | | | |
| 13 | 100% PB | 12 × 20 | 90 | 20.7 | — | 1759 | 9.3 | 0.20 | 16356 | 3222 |
| | 0400⁽⁶⁾ (web | | | | | | | | | |
| | annealed 20 min.) | | | | | | | | | |
| 14 | VISTAMAXX | 40 × 140 | 93 | 21.1 | 6.2 | 10164 | 1.6 | 0.24 | 15888 | 3752 |
| | VM2330⁽⁸⁾ | | | | | | | | | |
| 15 | 100% PB | 12 × 20 | 90 | 20.7 | — | 1861 | 8.2 | 0.20 | 15262 | 3007 |
| | 0400⁽⁶⁾ (web | | | | | | | | | |
| | annealed 5 min.) | | | | | | | | | |
| 16 | 20% FINA | 12 × 20 | 89 | 20.3 | — | 1833 | 8.1 | 0.20 | 14847 | 2969 |
| | 3868⁽⁵⁾ + 80% | | | | | | | | | |
| | PB 0400⁽⁶⁾ | | | | | | | | | |
| | (web annealed 5 min.) | | | | | | | | | |
| 17 | FINA 3960⁽⁹⁾ | 12 × 20 | 90 | 21 | — | 1311 | 11.3 | 0.15 | 14814 | 2222 |
| 18 | 76% FINA | 40 × 140 | 90 | 20 | — | 3834 | 3.8 | 0.16 | 14569 | 2331 |
| | 3960⁽⁹⁾ + 24% | | | | | | | | | |
| | E-1200⁽¹⁰⁾ | | | | | | | | | |
| 19 | FINA 3960⁽⁹⁾ | 40 × 140 | 91 | 16.1 | — | 4478 | 3.2 | 0.17 | 14330 | 2436 |
| 20 | FINA 3960⁽⁹⁾ | 40 × 140 | 89 | 20 | — | 3588 | 3.8 | 0.14 | 13634 | 1909 |
| 21 | KRATON | 12 × 20 | 88 | 21.9 | — | 2422 | 5.6 | 0.22 | 13563 | 2984 |
| | G1657⁽¹⁰⁾ | | | | | | | | | |
| 22 | 76% FINA | 12 × 20 | 90 | 18.9 | — | 1389 | 8.3 | 0.16 | 11525 | 1844 |
| | 3960⁽⁹⁾ + 24% E- | | | | | | | | | |
| | 1200⁽¹¹⁾ | | | | | | | | | |
| 23 | FINA 3960⁽⁹⁾ | 12 × 20 | 90 | 20 | — | 1348 | 8 | 0.15 | 10784 | 1618 |
| 24 | FINA 3960⁽⁹⁾ | 12 × 20 | 91 | 18.1 | — | 1440 | 7.2 | 0.15 | 10368 | 1555 |
| 25 | DOWLEX | 12 × 20 | 90 | 20.4 | — | 1942 | 5.3 | 0.19 | 10290 | 1955 |
| | 2503⁽¹²⁾ | | | | | | | | | |
| 26 | FINA 3960⁽⁹⁾ | 40 × 140 | 89 | 19 | — | 3271 | 2.7 | 0.14 | 8832 | 1236 |
| 27 | FINA 3960⁽⁹⁾ | 12 × 20 | 91 | 19.7 | — | 1216 | 6.3 | 0.14 | 7659 | 1072 |

⁽¹⁾EXACT 3040 is an ethylene hexene or ethylene octene copolymer available under the trade designation EXACT ™ from ExxonMobil Chemical Company.
⁽²⁾PS440-200 is a thermoplastic polyurethane elastomer available under the trade designation IROGRAN ™ from Huntsman LLC.
⁽³⁾VISTAMAXX VM2125 is a polyolefin elastomer available under the trade designation VISTAMAXX ™ from ExxonMobil Chemical Company.
⁽⁴⁾ENGAGE 8402 is a polyolefin elastomer available under the trade designation ENGAGE ™ from Dow Chemical Company.
⁽⁵⁾FINA 3846 is a polypropylene homopolymer available under the trade designation FINA ™ from Atofina Chemicals, Inc.
⁽⁶⁾PB 0400 is Grade PB 0400 thermoplastic polybutylene elastomer available from Basell Polyolefins.
⁽⁷⁾DOWLEX 2517 is a linear low density polyethylene available under the trade designation DOWLEX ™ from Dow Chemical Company.
⁽⁸⁾VISTAMAXX VM2330 is a polyolefin elastomer available under the trade designation VISTAMAXX ™ from ExxonMobil Chemical Company.
⁽⁹⁾FINA 3960 is a polypropylene homopolymer available under the trade designation FINA ™ from Atofina Chemicals, Inc.
⁽¹⁰⁾KRATON G1657 is a styrenic di-/triblock copolymer available under the trade designation KRATON ™ from Kraton Polymers.
⁽¹¹⁾E-1200 is an amorphous propylene-ethylene copolymer available under the trade designation EASTOFLEX ™ from Eastman Chemicals.
⁽¹²⁾DOWLEX 2503 is a linear low density low molecular weight polyethylene resin formerly available under the trade designation DOWLEX ™ from Dow Plastics.

The data in Table 1 show that very high Adsorption Factor A values could be obtained. Surprisingly, the Run No. 1 web exhibited a greater Adsorption Factor A than the packed carbon bed of Run No. 2. The Run No. 2 web also exhibited a greater Adsorption Factor A than the packed carbon bed of Run No. 2, but as shown below an unloaded web made from the same thermoplastic polyurethane was not DMMP resistant. Webs made from polypropylene (Run Nos. 17, 19, 20, 23, 24, 26 and 27) would be DMMP resistant but as shown above had Adsorption Factor A values no greater than 1.5×10⁴/mm water.

Sorbent particle-free (viz., unloaded) versions of webs made from the Run Nos. 1, 2, 4, 5, 8, 10 and 14 polymeric materials were prepared using an apparatus like that shown in FIG. 6 in which sorbent particles 74 were not permitted to fall from feed roll 78 into the web. The Run No. 2 polymeric material was used to form a 192 g/m² unloaded web from two layers of 96 g/m² unloaded web. The other polymeric materials (viz., those of Run Nos. 1, 2, 4, 5, 8, 10 and 14) were used to form single layer webs with an approximate 200 g/m² basis weight. Swatches were cut from the resulting unloaded webs, weighed, exposed to air saturated with DMMP vapor for 6 and in most cases 23 days and reweighed to determine the swatch mass and the percent DMMP uptake expressed as a percent of the initial swatch mass. The unloaded web made from the Run No. 2 thermoplastic polyurethane (see Run No. 33, below) was sufficiently degraded after 6 days exposure to prevent taking further weight gain measurements. Set out below in Table 2 are the Run Number, polymeric material, unloaded web basis weight, initial sample mass, and the mass and percent DMMP uptake (expressed as a percent of the initial sample mass) for each sample after 6 or 23 days. The entries in Table 2 are sorted in ascending order according to the percent DMMP uptake after the longest measurement period employed.

TABLE 2

| | | | | | | | % |
|---|---|---|---|---|---|---|---|
| | | | | | % DMMP | Mass | DMMP |
| | | Basis | Initial | Mass | Uptake | After | Uptake |
| | Polymeric | Weight, | Sample | After 6 | After 6 | 23 | After |
| Run No. | Material | gsm | Mass, g | Days, g | Days | Days, g | 23 Days |
| 28 | EXACT 3040 | 202 | 0.402 | 0.403 | 0.25 | 0.402 | 0 |
| 29 | DOWLEX | 205 | 0.430 | 0.431 | 0.23 | 0.431 | 0.23 |
| | 2517 | | | | | | |
| 30 | VISTAMAXX | 198 | 0.416 | 0.417 | 0.24 | 0.417 | 0.24 |
| | VM2125 | | | | | | |
| 31 | ENGAGE | 208 | 0.453 | 0.454 | 0.22 | 0.455 | 0.44 |
| | 8402 | | | | | | |
| 32 | VISTAMAXX | 203 | 0.377 | 0.378 | 0.27 | 0.379 | 0.53 |
| | VM2330 | | | | | | |
| 33 | PS440-200 | 192 | 0.373 | 0.454 | 21.7 | — | — |

The data in Table 2 shows that unloaded webs made from several polymers exhibiting very high Adsorption Factor A values in Table 1 could also resist DMMP vapor exposure. The unloaded web made from thermoplastic polyurethane (Run No. 33) did not survive DMMP vapor exposure, and its exposure test was discontinued after 6 days.

Using the method employed for Table 2, two additional unloaded webs were prepared using blends of polymeric materials. The webs were made by combining 90:10 or 50:50 mixtures of the polyolefin elastomer ENGAGE 8402 (see Run No. 5 from Table 1) and the styrenic block copolymer KRATON G1657 (see Run No. 21 from Table 1) in an extruder and then melt-blowing the extruded mixture to form a single layer unloaded web. Small swatches of the unloaded web samples were weighed, exposed to DMMP vapor for 11 days and reweighed. Set out below in Table 3 are the Run Number, polymeric materials in the blend, unloaded web basis weight, initial sample mass, and the mass and percent DMMP uptake (expressed as a percent of the initial sample mass) after 11 days.

TABLE 3

| | | | | | % DMMP |
|---|---|---|---|---|---|
| | | Basis | Initial | Mass | Uptake |
| Run | | Weight, | Sample | After 11 | After 11 |
| No. | Polymeric Material | gsm | Mass, g | Days, g | Days |
| 34 | 90% ENGAGE 8402 + | 112 | 0.214 | 0.217 | 1.40 |
| | 10% KRATON G1657 | | | | |
| 35 | 50% ENGAGE 8402 + | 118 | 0.269 | 0.274 | 1.86 |
| | 50% KRATON G1657 | | | | |

The data in Table 3 shows that unloaded webs made from the blended polymers exhibited reasonably good DMMP resistance. Exposing the web for 11 days represents a more stringent test than a 6 day exposure, and the sample sizes were smaller than those used in Table 2 and thus somewhat more subject to weighing errors. Had the Run No. 35 blend been exposed for only 6 days (or had the blend ratio or polymeric components been adjusted slightly), it might exhibit no more than about 1 weight percent DMMP uptake. It might also have done so over the 11 day exposure period had a larger sample swatch been employed.

### EXAMPLE 2

A variety of thermoplastic polymers were formed into discs by pressing extrusion grade pellets as received from the polymer manufacturer in a heated laboratory hydraulic press (available from Carver, Inc.). The press was equipped with stainless steel platens covered with polytetrafluoroethylene liners. A bump stop made from 0.5 mm feeler gauge stock was employed to regulate the disc thickness. The press temperature was varied depending on the particular polymer being pressed but generally was set to about 200-250° C. Pressures of about 207 kPa and pressing times of about 15 seconds were employed. The resulting resin coupons were folded and repressed until air gaps and other imperfections were removed, to provide discs with target dimensions of about 50 mm diameter and 0.5 mm thickness. The discs were placed in a desiccator and arranged for even exposure to the desiccator internal atmosphere. Sufficient DMMP to provide a saturated internal atmosphere was also placed in the desiccator. The discs were weighed initially and at various time intervals to determine the disc mass and the percent DMMP uptake expressed as a percent of the initial disc mass. The physical state of each disc and the occurrence of visible degradation were also noted. Set out below in Table 4 are the Run No., polymeric material, initial disc mass, and the percent DMMP uptake after 13 hours and 4 days. The entries in Table 4 are sorted in descending order according to the percent DMMP uptake after 13 hours.

TABLE 4

| | | | | % |
|---|---|---|---|---|
| | | | % DMMP | DMMP |
| | | Initial | Uptake | Uptake |
| Run | | Disc | After 13 | After 4 |
| No. | Polymeric Material | Mass, g | Hours | Days |
| 1 | PS455-20A⁽¹⁾ | 0.765 | 3.92 | 22.2⁽¹⁶⁾ |
| 2 | PS440-200⁽²⁾ | 0.701 | 3.57 | 18.8⁽¹⁷⁾ |
| 3 | PS164-400⁽³⁾ | 0.736 | 3.13 | 21.9⁽¹⁸⁾ |
| 4 | Polyolefin alloy⁽⁴⁾ | 0.600 | 2.83 | 13.5⁽¹⁷⁾ |
| 5 | HYTREL 4556⁽⁵⁾ | | | 10.6 |
| 6 | CA 100-200⁽⁶⁾ | 0.815 | 1.47 | 9.94⁽¹⁸⁾ |
| 7 | BYNEL 3022⁽⁷⁾ | 0.499 | 1.40 | 8.82 |
| 8 | PE90-208⁽⁸⁾ | 0.815 | 1.35 | 13.9 |
| 9 | THV 220G⁽⁹⁾ | 1.177 | 0.93 | 4.25 |
| 10 | SOLTEX PVDF⁽¹⁰⁾ | 1.228 | 0.57 | 4.32 |
| 11 | ELVAX 3174⁽¹¹⁾ | 0.607 | 0.49 | 0.66 |
| 12 | THV 500G⁽¹²⁾ | 1.155 | 0.26 | 0.61 |
| 13 | ENGAGE 8401⁽¹³⁾ | 0.538 | 0.19 | 0.37 |
| 14 | VISTAMAXX VM3000⁽¹⁴⁾ | 0.507 | 0.0 | 0.2 |
| 15 | ENGAGE 8411⁽¹⁵⁾ | 0.516 | 0.0 | 0.2 |

⁽¹⁾PS455-20A is a thermoplastic polyurethane elastomer available under the trade designation IROGRAN ™ from Huntsman LLC.
⁽²⁾PS440-200 is a thermoplastic polyurethane elastomer available under the trade designation IROGRAN ™ from Huntsman LLC.
⁽³⁾PS164-400 is a thermoplastic polyurethane elastomer available under the trade designation IROGRAN ™ from Huntsman LLC.
⁽⁴⁾Polyolefin alloy is product no. FM 060105-4 available from Noveon, Inc.
⁽⁵⁾HYTREL 4556 is a thermoplastic polyester available under the trade designation HYTREL ™ from E. I. DuPont de Nemours & Co.
⁽⁶⁾CA 100-200 is a thermoplastic polyurethane elastomer available under the trade designation IROGRAN ™ from Huntsman LLC.
⁽⁷⁾BYNEL 3022 is an anhydride-modified ethylene vinyl acetate polyester available under the trade designation HYTREL ™ from E. I. DuPont de Nemours & Co.
⁽⁸⁾PE90-208 is a thermoplastic polyurethane elastomer available under the trade designation IROGRAN ™ from Huntsman LLC.
⁽⁹⁾THV 220G is a fluorothermoplastic terpolymer available under the trade designation THV ™ from Dyneon, LLC.
⁽¹⁰⁾SOLTEX PVDF is a thermoplastic polyvinylidene fluoride resin available under the trade designation SOLTEX ™ from Solvay Solexis.
⁽¹¹⁾ELVAX 3174 is an ethylene vinyl acetate polymer available under the trade designation ELVAX ™ from E. I. DuPont de Nemours & Co.
⁽¹²⁾THV 500G is a fluorothermoplastic terpolymer available under the trade designation THV ™ from Dyneon, LLC.
⁽¹³⁾ENGAGE 8401 is a polyolefin elastomer available under the trade designation ENGAGE ™ from Dow Chemical Company.
⁽¹⁴⁾VISTAMAXX VM3000 is a polyolefin elastomer available under the trade designation VISTAMAXX ™ from ExxonMobil Chemical Company.
⁽¹⁵⁾ENGAGE 8411 is a polyolefin elastomer available under the trade designation ENGAGE ™ from Dow Chemical Company.
⁽¹⁶⁾Sample was limp, and saturated with DMMP.
⁽¹⁷⁾Sample exhibited severe distortion and warping.
⁽¹⁸⁾Sample exhibited moderate distortion.

The data in Table 4 shows relative resistance to DMMP uptake of discs made from a Variety of polymeric materials. Exposing a disc for a few hours or even a few days to DMMP vapor may represent a less stringent-test than exposing an unloaded web made from the same polymer for 6 days. However, preparing polymer disc samples is easier and less expensive than making a web and may provide a useful predictor for the resistance to DMMP uptake of a web made from the same or a similar polymeric material.

### COMPARISON EXAMPLE

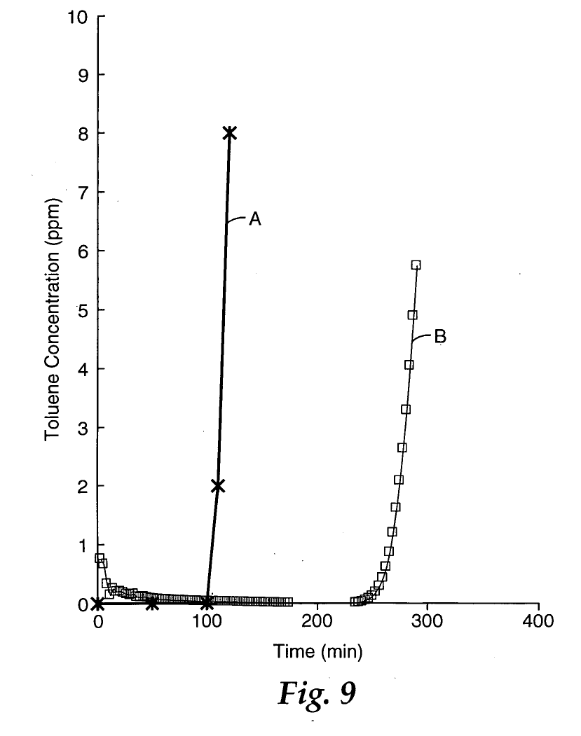

Using the general method of Example 1, a single layer web was made using IROGRAN PS440-200 thermoplastic polyurethane and 40×140 carbon granules. The completed web contained 0.202 g/cm² carbon (91 wt. % carbon) and had a 15 micrometer effective fiber diameter. An 81 cm² sample of this web containing 16.4 g total carbon was exposed to <35% relative humidity air flowing at 14 L/min and containing 250 ppm toluene vapor. FIG. 9 shows a plot of the downstream toluene concentration for this web (Curve B) and for a web (Curve A) made according to Example 19 of U.S. Pat. No. 3,971,373 (Braun). The Braun Example 19 web contained polypropylene fibers and 17.4 g total carbon (89 wt. % carbon). As shown in FIG. 9, the Braun Example 19 web exhibited substantially less adsorption capacity, even though the above-described polyurethane-based web contained less carbon. The polyurethane-based web's improved performance is believed to be due to its greater Adsorption Factor A.

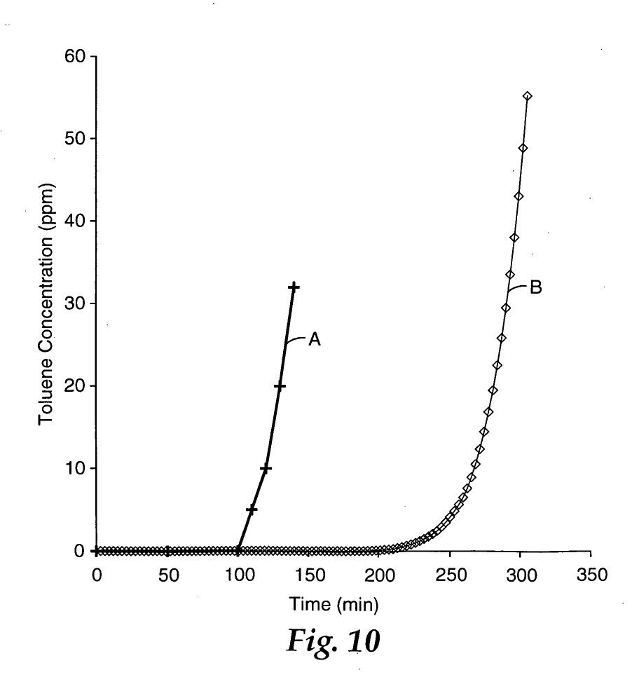

A two layer polyurethane-based web was made according to the general method of Example 1, using IROGRAN PS440-200 thermoplastic polyurethane, 12×20 carbon granules in the first layer and 40×140 carbon granules in the second layer. The first layer contained 0.154 g/cm² carbon (91 wt. % carbon) and had a 26 micrometer effective fiber diameter. The second layer contained 0.051 g/cm² carbon (91 wt. % carbon) and had a 15 micrometer effective fiber diameter. An 81 cm² sample of this two-layer polyurethane-based web containing 16.6 g total carbon was exposed to <35% relative humidity air flowing at 14 L/min and containing 350 ppm toluene vapor. FIG. 10 shows a plot of the downstream toluene concentration for this two-layer polyurethane-based web (Curve B) and for a web (Curve A) made according to Braun Example 20. The Braun Example 20 web contained polypropylene fibers and 18.9 g total carbon (85 wt. % carbon). As shown in FIG. 10, the Braun Example 20 web exhibited substantially less adsorption capacity, even though the above-described two-layer polyurethane-based web contained less carbon. The two-layer polyurethane-based web's improved performance is again believed to be due to its greater Adsorption Factor A.

Various modifications and alterations of this invention will be apparent to those skilled in the art and informed by the present specification without departing from this invention. This invention should not be restricted to that which has been set forth herein only for illustrative purposes.

We claim:

1. A porous sheet article comprising a self-supporting nonwoven web of less than 20 weight percent polymeric fibers exhibiting no more than about 1 weight percent dimethyl methyl phosphonate uptake and at least 80 weight percent sorbent particles enmeshed in the web, the sorbent particles being sufficiently evenly distributed in the web and the fiber polymer(s) being such that the web has an Adsorption Factor A of at least 1.6×10⁴/mm water.

2. An article according to claim 1 comprising a plurality of nonwoven web layers.

3. An article according to claim 1 wherein the fibers comprise thermoplastic ethylene hexene or ethylene octene copolymer.

4. An article according to claim 1 wherein the fibers comprise thermoplastic polyolefin elastomer.

5. An article according to claim 1 wherein the sorbent particles comprise activated carbon or alumina.

6. An article according to claim 1 wherein at least 84 weight percent sorbent particles are enmeshed in the web.

7. An article according to claim 1 wherein at least 90 weight percent sorbent particles are enmeshed in the web.

8. An article according to claim 1 having an Adsorption Factor A of at least 2×10⁴/mm water.

9. An article according to claim 1 having an Adsorption Factor A of at least 3×10⁴/mm water.

10. An article according to claim 1 comprising a filter comprising a housing supporting the porous sheet article.

11. An article according to claim 1 comprising a prefilter or postfilter comprising the porous sheet article, in combination with a further filter structure.

12. An article according to claim 1 comprising a chemical protective suit, hood, individual enclosure or other individual protective equipment or device into which air is filtered through the porous sheet article.

13. An article according to claim 1 comprising a shelter or other collective protection equipment or device into which air is filtered through the porous sheet article.

14. A process for making a porous sheet article comprising a self-supporting nonwoven web of polymeric fibers and sorbent particles, the process comprising:
a) flowing molten polymer through a plurality of orifices to form filaments;
b) attenuating the filaments into fibers;
c) directing a stream of sorbent particles amidst the filaments or fibers; and
d) collecting the fibers and sorbent particles as a nonwoven web comprising less than 20 weight percent polymeric fibers exhibiting no more than about 1 weight percent dimethyl methyl phosphonate uptake and at least 80 weight percent sorbent particles enmeshed in the web
wherein the sorbent particles are sufficiently evenly distributed in the web and the polymer is such that that the web has an Adsorption Factor A of at least 1.6×10⁴/mm water.

15. A process according to claim 14 comprising meltblowing the filaments.

16. A process according to claim 14 wherein the molten polymer comprises thermoplastic ethylene hexene or ethylene octene copolymer.

17. A process according to claim 14 wherein the molten polymer comprises thermoplastic polyolefin elastomer.

18. A process according to claim 14 wherein the sorbent particles comprise activated carbon or alumina.

19. A process according to claim 14 wherein at least 84 weight percent sorbent particles are enmeshed in the web.

20. A process according to claim 14 wherein at least 90 weight percent sorbent particles are enmeshed in the web.

21. A process according to claim 14 wherein the web has an Adsorption Factor A of at least 2×10⁴/mm water.

22. A process according to claim 14 wherein the web has an Adsorption Factor A of at least 3×10⁴/mm water.

23. A respiratory device having an interior portion that generally encloses at least the nose and mouth of a wearer, an air intake path for supplying ambient air to the interior portion, and a porous sheet article disposed across the air intake path to filter such supplied air, the porous sheet article comprising a self-supporting nonwoven web of less than 20 weight percent polymeric fibers exhibiting no more than about 1 weight percent dimethyl methyl phosphonate uptake and at least 80 weight percent sorbent particles enmeshed in the web, the sorbent particles being sufficiently evenly distributed in the web and the fiber polymer(s) being such that the article has an Adsorption Factor A of at least 1.6×10⁴/mm water.

24. A respiratory device according to claim 23 wherein the polymeric fibers comprise thermoplastic ethylene hexene or ethylene octene copolymer.

25. A respiratory device according to claim 23 wherein the polymeric fibers comprise thermoplastic polyolefin elastomer.

26. A respiratory device according to claim 23 wherein the sorbent particles comprise activated carbon or alumina.

27. A respiratory device according to claim 23 wherein at least 84 weight percent sorbent particles are enmeshed in the web.

28. A respiratory device according to claim 23 wherein at least 90 weight percent sorbent particles are enmeshed in the web.

29. A respiratory device according to claim 23 wherein the web has an Adsorption Factor A of at least 2×10⁴/mm water.

30. A respiratory device according to claim 23 wherein the web has an Adsorption Factor A of at least 3×10⁴/mm water.

31. A replaceable filter element for a respiratory device, the element comprising a support structure for mounting the element on the device, a housing and a porous sheet article disposed in the housing so that the element can filter air passing into the device, the article comprising a self-supporting nonwoven web of less than 20 weight percent polymeric fibers exhibiting no more than about 1 weight percent dimethyl methyl phosphonate uptake and at least 80 weight percent sorbent particles enmeshed in the web, the sorbent particles being sufficiently evenly distributed in the web and the fiber polymer(s) being such that that the element has an Adsorption Factor A of at least 1.6×10⁴/mm water.

32. A filter element according to claim 31 wherein the polymeric fibers comprise thermoplastic ethylene hexene or ethylene octene copolymer.

33. A filter element according to claim 31 wherein the polymeric fibers comprise thermoplastic polyolefin elastomer.

34. A filter element according to claim 31 wherein the sorbent particles comprise activated carbon or alumina.

35. A filter element according to claim 31 wherein at least 84 weight percent sorbent particles are enmeshed in the web.

36. A filter element according to claim 31 wherein at least 90 weight percent sorbent particles are enmeshed in the web.

37. A filter element according to claim 31 wherein the web has an Adsorption Factor A of at least 2×10⁴/mm water.

38. A filter element according to claim 31 wherein the web has an Adsorption Factor A of at least 3×10⁴/mm water.

39. A filter element according to claim 31 having a greater Adsorption Factor A than would be exhibited by a packed carbon bed disposed in the housing.
